(19) United States
(12) Patent Application Publication
(10) Pub. No.: US 2026/0328919 A1
(43) Pub. Date: Oct. 22, 2026

(54) METHOD FOR IDENTIFYING UTILITY POLE POSITION FROM VIBRATION DISTRIBUTION WAVEFORM

(71) Applicant: NTT, Tokyo (JP)

(72) Inventors: Tatsuyai OKAMOTO, Musashino-shi, Tokyo (JP); Daisuke IIDA, Musashino-shi, Tokyo (JP); Yusuke KOSHIKIYA, Musashino-shi, Tokyo (JP)

(73) Assignee: NTT, Tokyo (JP)

(21) Appl. No.: 19/106,838

(22) PCT Filed: Sep. 15, 2022
(86) PCT No.: PCT/JP2022/034580

§ 371 Date: Feb. 26, 2025

(51) Int. Cl. G01S 11/14; G01H 9/00

(52) U.S. Cl. CPC G01S 11/14; G01H 9/004

(57) ABSTRACT

The present disclosure is a vibration analysis device and a vibration analysis method that perform filtering on a vibration distribution waveform, indicating a temporal change in a spatial distribution in a longitudinal direction of vibration of an aerial optical fiber cable, with a high-pass filter having a cutoff frequency higher than a spatial frequency of the vibration; and identify a utility pole location by performing envelope detection on a filtering waveform obtained by the filtering.

### TECHNICAL FIELD

The present disclosure relates to vibration distribution sensing technology.

### BACKGROUND ART

Vibration distribution sensing (DVS: distributed vibration sensing) for acquiring a vibration distribution of an aerial optical fiber cable using optical time domain reflectometry (OTDR), optical frequency domain reflectometry (OFDR), or the like and analyzing the vibration distribution has been proposed (see, for example, Non Patent Literature 1). When the measurement performance of the vibration distribution obtained by the measurement is higher than time and spatial frequencies that are the vibration characteristics of the aerial optical fiber cable, the Nyquist theorem is satisfied, and the vibration of the aerial optical fiber cable can be faithfully measured.

The vibration distribution of the aerial optical fiber cable can be regarded as an independent vibration system in each span, a section in which the propagation of vibration is continuous represents the aerial optical fiber cable, and a spot of discontinuation represents a boundary point between adjacent vibration systems, that is, a utility pole. However, since there is no algorithm for automatically identifying the utility pole location, the spot of discontinuation of the vibration distribution waveform is visually identified.

### CITATION LIST

### Non Patent Literature

Non Patent Literature 1: Okamoto, Tatsuya, et al. “Deployment Condition Visualization of Aerial Optical Fiber Cable By Distributed Vibration Sensing Based On Optical Frequency Domain Reflectometry.” Journal of Lightwave Technology 39.21 (2021):6942-6951.

### SUMMARY OF INVENTION

### Technical Problem

The vibration distribution waveform has vague discontinuity of the vibration systems unclear in some cases. Therefore, an object of the present disclosure is to practicalize identification of a utility pole location, without relying on visual observation, from the vibration distribution waveform of an aerial optical fiber cable.

### Solution to Problem

A vibration analysis device and a vibration analysis method of the present disclosure
perform filtering on a vibration distribution waveform, indicating a temporal change in a spatial distribution in a longitudinal direction of vibration of an aerial optical fiber cable, with a high-pass filter having a cutoff frequency higher than a spatial frequency of the vibration; and
identify a utility pole location by performing envelope detection on a filtering waveform obtained by the filtering.

As the cutoff frequency, any frequency higher than the spatial frequency of vibration may be adopted.

The vibration analysis device and the vibration analysis method of the present disclosure may extract only a traveling wave component or a backward wave component in the longitudinal direction of the vibration from the vibration distribution waveform; and perform the filtering on the extracted traveling wave component or backward wave component.

Note that the above-described disclosures can be combined in any possible manner.

### Advantageous Effects of Invention

The present disclosure is capable of practicalizing identification of the utility pole location, without relying on visual observation, from the vibration distribution waveform of an aerial optical fiber cable.

### BRIEF DESCRIPTION OF DRAWINGS

FIG. 1 illustrates an example of a vibration distribution waveform F0.

FIG. 2 illustrates an example of a utility pole location on a vibration distribution waveform.

FIG. 3 illustrates a system configuration example of the present disclosure.

FIG. 4 illustrates an example of a vibration analysis method of the present disclosure.

FIG. 5 illustrates an example of a spectrum S1 determined by spatial frequency k and time frequency w.

FIG. 6 illustrates an example of a unidirectional spectrum S2.

FIG. 7 illustrates an example of a unidirectional vibration distribution waveform F1.

FIG. 8 illustrates an example of a high-pass filtering waveform F2.

FIG. 9 illustrates an example of a high-pass filtering waveform F3 analyzed by envelope detection.

### DESCRIPTION OF EMBODIMENTS

Hereinafter, an embodiment of the present disclosure will be described in detail with reference to the drawings. Note that the present disclosure is not limited to the embodiment described below. These embodiments are merely exemplifications, and the present disclosure can be carried out in forms with various changes and improvements on the basis of the knowledge of those skilled in the art. Note that components indicated by the same reference signs in the present specification and the drawings are the same components.

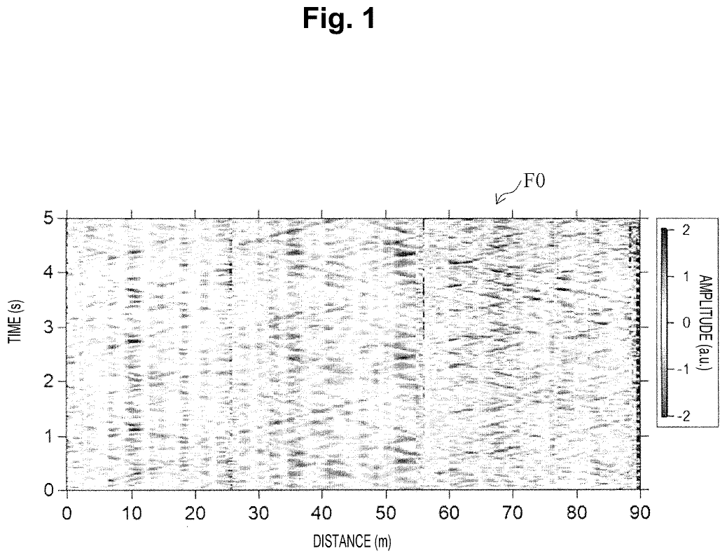

FIG. 1 illustrates an example of a vibration distribution waveform. In the present disclosure, a vibration distribution waveform of vibration of an aerial optical fiber cable is used. By measuring distortion arisen at each point in the longitudinal direction of the optical fiber using OTDR, OFDR, or the like, a vibration distribution waveform in the longitudinal direction of the optical fiber can be obtained. The vibration distribution waveform includes two distributions: a spatial distribution in the longitudinal direction of the aerial optical fiber cable and a temporal change, that is, a time distribution. In the drawing, an example of a two-dimensional distribution determined by distance (m) in the longitudinal direction of the aerial optical fiber cable and time(s) is illustrated.

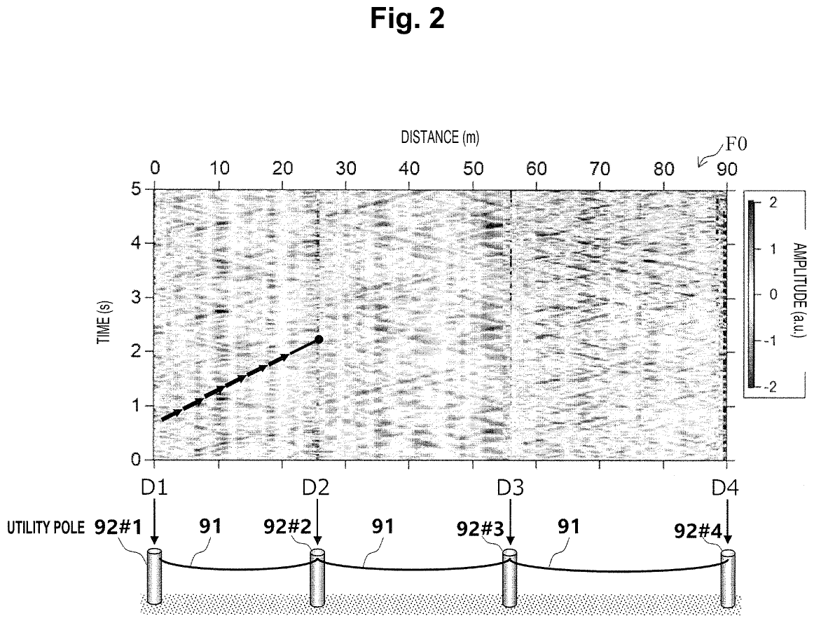

The vibration propagating along the aerial optical fiber cable exhibits continuous behavior over one span between utility poles as indicated by the arrows in FIG. 2. Since the propagation of vibration along an aerial optical fiber cable 91 is interrupted by a utility pole 92, the vibration distribution waveform is discontinuous at distances D1, D2, D3, and D4, which are utility pole locations. A vibration analysis device of the present disclosure executes a vibration analysis method of the present disclosure to identify the distance at which the utility pole is located.

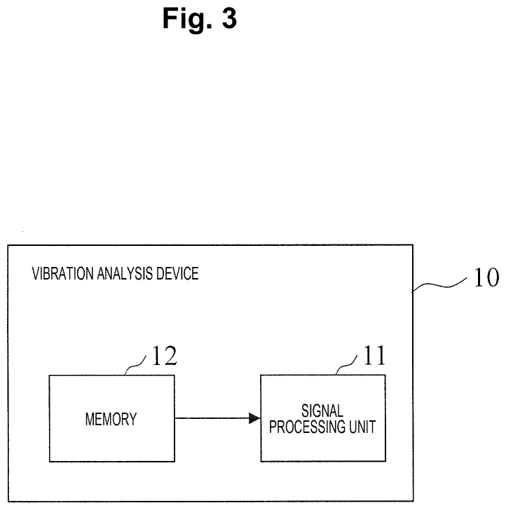

FIG. 3 illustrates a configuration example of the vibration analysis device of the present disclosure. A vibration analysis device 10 of the present disclosure includes a signal processing unit 11 and a memory 12. The memory 12 stores a vibration distribution waveform in the longitudinal direction of the aerial optical fiber cable. Note that the vibration distribution waveform may be calculated from a result measured by OTDR, OFDR, or the like in the signal processing unit 11.

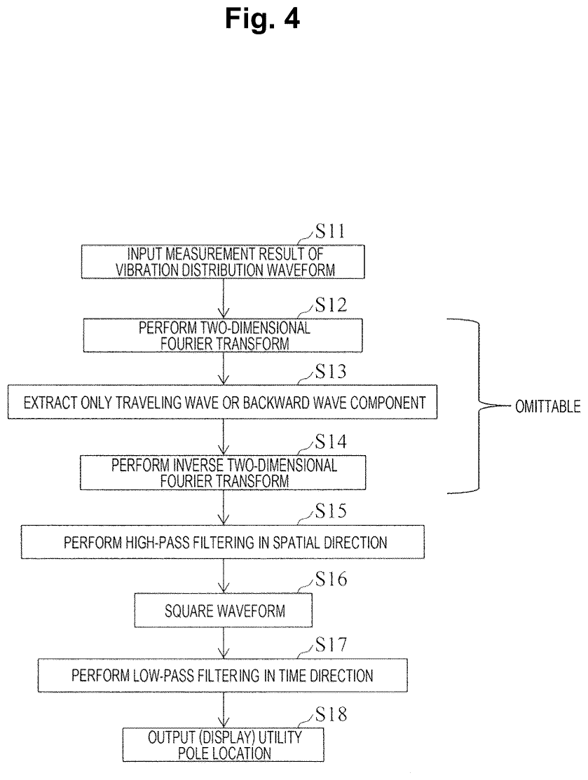

FIG. 4 illustrates an example of a vibration analysis method of the present disclosure. In the vibration analysis method of the present disclosure, the signal processing unit 11 sequentially executes the steps described below.
Step S11: Acquiring the vibration distribution waveform F0 from the memory 12.
Step S15: Performing a high-pass filtering in a spatial direction on the vibration distribution waveform F0.
Step S16: Calculating the square of the high-pass filtering waveform F2 after the high-pass filtering.
Step S17: Performing envelope detection on the high-pass filtering waveform F2.
Step S18: Outputting (displaying) the utility pole location using the detection result.

The steps described below may be sequentially interposed between Steps S11 and S15.
Step S12: Performing two-dimensional Fourier transform on the vibration distribution waveform FO to obtain a spectrum S1 determined by a spatial frequency.
Step S13: Extracting only a traveling wave or backward wave component from the spectrum S1 to obtain a unidirectional spectrum S2.
Step S14: Performing inverse two-dimensional Fourier transform on the traveling wave or backward wave component to obtain a unidirectional vibration distribution waveform F1.

In this regard, in Step S15, high-pass filtering in a spatial direction is performed on the vibration distribution waveform F1.

Each step will be described in detail.

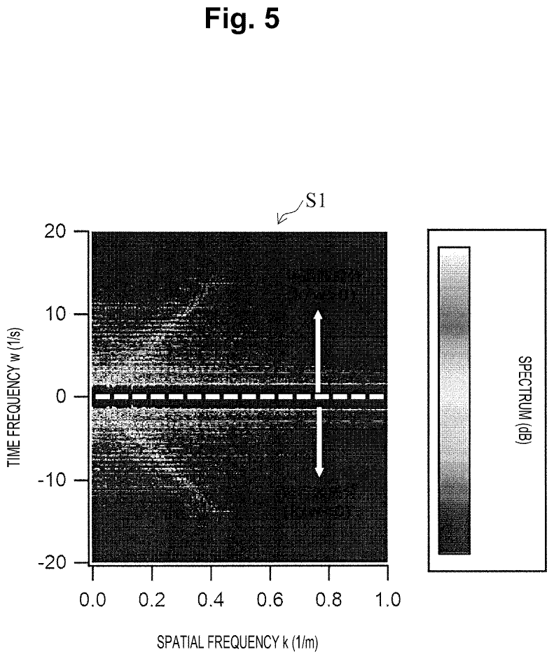

In Step S11, a vibration distribution waveform, as illustrated in FIG. 1, is acquired. After Step S12 is executed, the spectrum S1 (dB) determined by the spatial frequency k and the time frequency w, as illustrated in FIG. 5, is obtained.

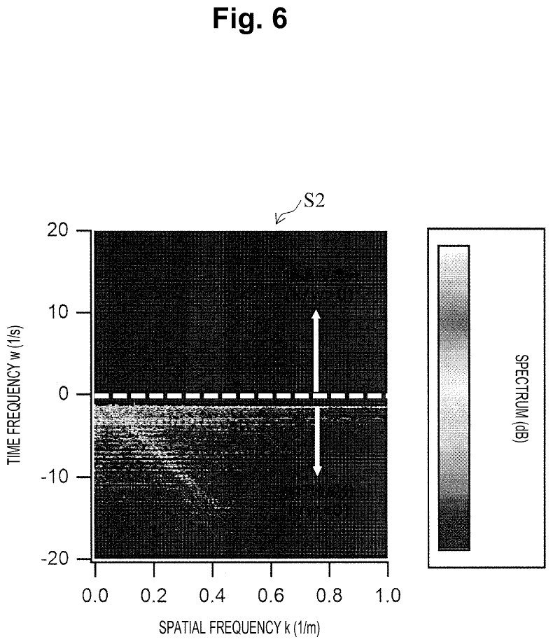

The spectrum S1 is divided into a traveling wave component of vibration (region of k/w<0) and a backward wave component of vibration (region of k/w>0), by the time frequency w=0. Therefore, Step S13 is executed to set the entire traveling wave component or backward wave component of the vibration to zero, and the vibration component in the forward direction (traveling wave) or backward direction (backward wave) in the longitudinal direction of the aerial optical fiber cable is extracted as a spectrum S2 illustrated in FIG. 6. By virtue of extracting the unidirectional component in this manner, the location of discontinuation of the vibration in the spatial direction can be conspicuous.

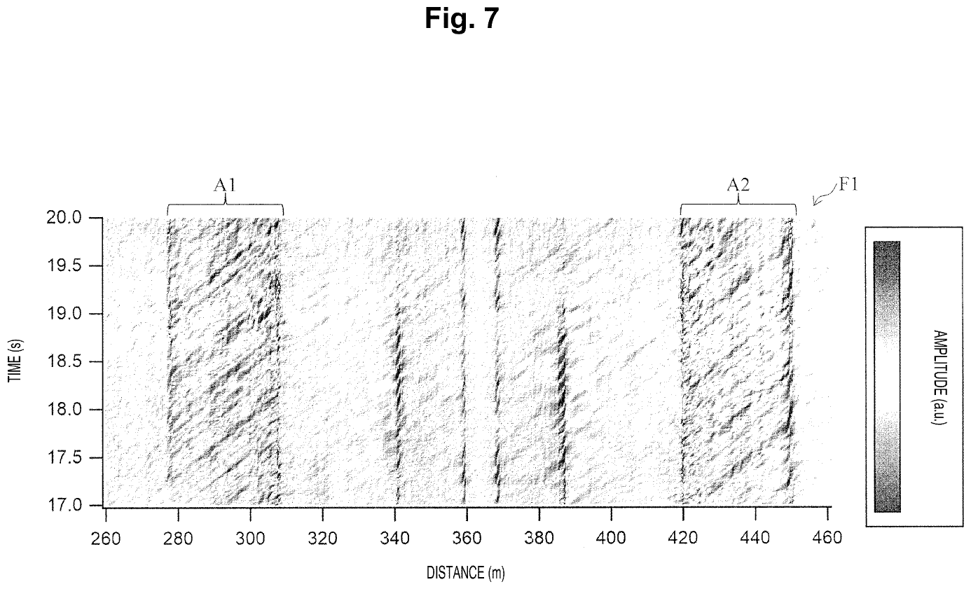

Step S14 is executed to perform inverse two-dimensional Fourier transform on the extracted spectrum S2. This can lead to the vibration distribution waveform F1 that emphasizes the discontinuity of vibration as illustrated in FIG. 7. In regard to this vibration distribution waveform F1, the amplitude is large within a region A1 ranging from around 275 m to around 310 m and a region A2 ranging from around 420 m to around 450 m.

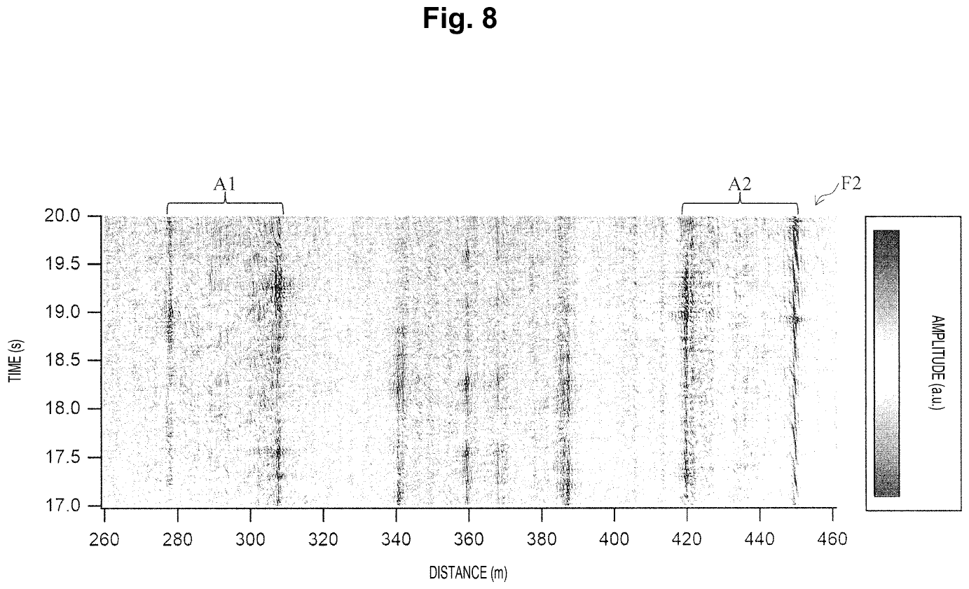

Since the vibration does not continue beyond the distance where the utility pole is present, Step S15 is executed: the high-pass filtering in the spatial direction is performed, on the vibration distribution waveform F1, at a cutoff frequency higher than the spatial frequency of the vibration. For example, in the example illustrated in FIG. 5, a cutoff frequency of 0.5 or more is used. This can lead to the high-pass filtering waveform F2 in which the vibration amplitude caused by the discontinuation of vibration within the regions A1 and A2 is extracted, as illustrated in FIG. 8.

Note that, in the two-dimensional spectrum of the vibration distribution waveform, (k, w) scattered on a straight line passing through (spatial frequency k=0, time frequency w=0) compose a vibration spectrum. For example, in FIG. 5, a straight line connecting (k=0, w=0), (k=0.3, w=10), and (k=0.3, w=−10) is a spectrum representing vibration. Since the largest kₘₐₓ on the straight line is the spatial frequency representing vibration, kₘₐₓ in the example illustrated in FIG. 5 is 0.5.

Envelope detection on the high-pass filtering waveform F2 is performed to emphasize spots of the discontinuation of the high-pass filtering waveform F2. The envelope detection is performed, for example, by performing low-pass filtering in the time direction. In this regard, low-pass filtering may be performed after squaring the high-pass filtering waveform.

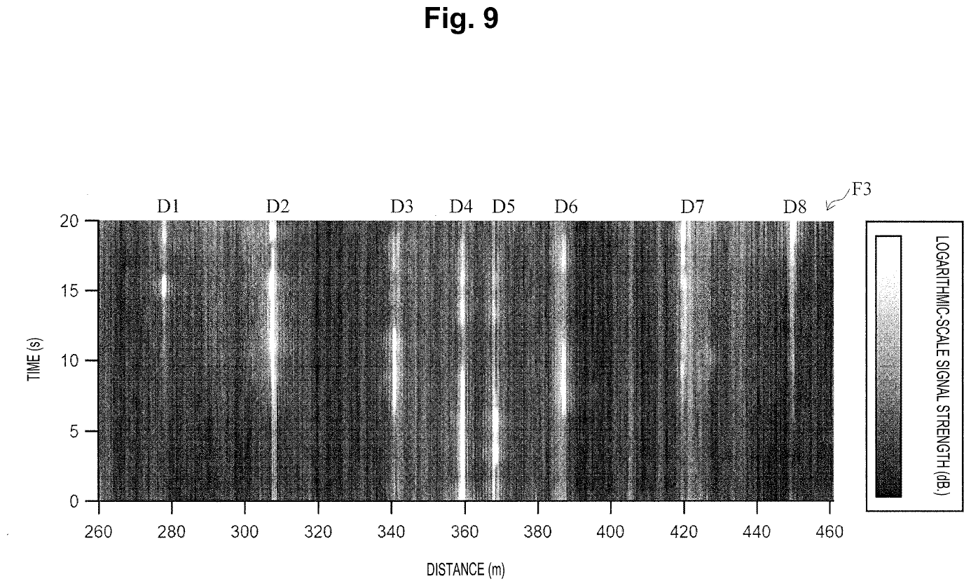

FIG. 9 illustrates an example of the high-pass filtering waveform F3 analyzed by envelope detection. The signal processing unit 11 may graph the amplitude of the high-pass filtering waveform F3, analyzed by envelope detection, with a logarithmic scale. This can further emphasize the spots of the discontinuation of the high-pass filtering waveform F2.

The signal processing unit 11 detects the emphasized distance and outputs the detected distance as the utility pole location. For example, a distance at which the amplitude exceeds a predetermined value is detected. In addition, this distance may be a distance at which the amplitude stays exceeding a predetermined value over a predetermined time. Here, the predetermined time may be continuous, or may be the sum of intermittently predetermined times. In the example of the present embodiment, since each distance of distances D1 to D8 is emphasized, the signal processing unit 11 outputs each distance of the distances D1 to D8 as the utility pole location.

### Effects of Present Disclosure

As described above, the present disclosure is capable of extracting the utility pole location by signal processing, without relying on visual observation, from the vibration distribution waveform of an aerial optical fiber cable.

Since the discontinuation of the vibration at the utility pole location has a statistical property, and a long measurement time facilitates observation of the discontinuation. Each span segment of the aerial optical fiber cable is an independent vibration system, but has almost the same frequency characteristics. For example, a point of the discontinuation (phases are unsynchronized) between a section of vibration at 1 Hz and a section of vibration at 10 Hz can be detected in a short measurement time by virtue of significant difference between these frequencies, but a point of the discontinuation between a section of 1 Hz and a section of 1.1 Hz needs detecting in a long measurement time.

Therefore, in Step S11, the signal processing unit 11 may acquire the vibration distribution waveform such that the time axis direction becomes longer than or equal to a predetermined time. For example, since the frequency difference between 1 Hz and 1.1 Hz is 0.1 Hz, and a minimum measurement time requires that a frequency resolution should be 0.1 Hz to distinguish between these two vibrations. Since the length of the measurement time and the frequency resolution have a reciprocal relationship, acquisition of the vibration distribution waveform requires that the sufficient measurement time should be ten seconds or more.

In the present disclosure, the vibration distribution can be faithfully measured, by performing the measurement in such a way as to satisfy the Nyquist theorem in sampling in the spatial and time directions.

In addition, in order to sense the discontinuation of vibration, the time scale (length of measurement time) may be longer than the time period of vibration. The time period of vibration depends on the laying condition of the aerial cable, but is about several seconds at the longest, and thus, the sufficient time scale is about one minute.

In addition, the distance scale (length in the distance direction) may be sufficiently larger than the width of the utility pole. Since the width of the utility pole is about 1 m, the sufficient distance scale is about 5 m.

The device of the present disclosure can also be achieved by a computer and a program, and the program can be recorded in a recording medium or can be provided via a network. A program according to the present disclosure is a program for implementation on a computer as each functional unit included in the device according to the present disclosure and is a program for directing a computer to perform each step included in a method performed by the device according to the present disclosure.

### REFERENCE SIGNS LIST

10 Vibration analysis device
11 Signal processing unit
12 Memory
91 Aerial optical fiber cable
92 Utility pole

1. A vibration analysis device that
performs filtering on a vibration distribution waveform, indicating a temporal change in a spatial distribution in a longitudinal direction of vibration of an aerial optical fiber cable, with a high-pass filter having a cutoff frequency higher than a spatial frequency of the vibration; and
identifies a utility pole location by performing envelope detection on a filtering waveform obtained by the filtering.

2. The vibration analysis device according to claim 1 that
extracts only a traveling wave component or a backward wave component in the longitudinal direction of the vibration from the vibration distribution waveform; and
performs the filtering on the extracted traveling wave component or backward wave component.

3. A vibration analysis method comprising:
performing filtering on a vibration distribution waveform, indicating a temporal change in a spatial distribution in a longitudinal direction of vibration of an aerial optical fiber cable, with a high-pass filter having a cutoff frequency higher than a spatial frequency of the vibration; and
identifying a utility pole location by performing envelope detection on a filtering waveform obtained by the filtering.
